(19) United States
(12) Patent Application Publication
(10) Pub. No.: US 2013/0244792 A1
(43) Pub. Date: Sep. 19, 2013

(54) GAME ENVIRONMENT UTILIZING A LOCK FREE MEMORY SYSTEM

(71) Applicants: Prashun Purkayastha, Bangalore (IN); Gopal Vijayaraghavan, Bangalore (IN); Prakash Ramachandran, Bangalore (IN)

(72) Inventors: Prashun Purkayastha, Bangalore (IN); Gopal Vijayaraghavan, Bangalore (IN); Prakash Ramachandran, Bangalore (IN)

(73) Assignee: Zynga Inc., San Francisco, CA (US)

(21) Appl. No.: 13/800,499

(22) Filed: Mar. 13, 2013

(30) Foreign Application Priority Data
Mar. 13, 2012 (IN) 729/DEL/2012

(51) Int. Cl. A63F 13/12

(52) U.S. Cl. CPC A63F 13/12
USPC 463/43

(57) ABSTRACT

A system, computer-readable storage medium storing at least one program, and a computer-implemented method for providing a game environment utilizing a lock free memory system are presented. For example, the computer-implemented method may include assigning a game instance to a first user, the game instance maintaining a state of a game instance record stored by a lock free memory system. An indication that a second user has performed a game action involving the game instance owned by the first user is then received. Responsive to receiving the indication, the method then stores a game delta in a game delta catalog. The game delta represents a change to the game instance associated with the first user.

### CLAIM TO PRIORITY

This application claims the benefit of priority under 35 U.S.C. §119 of Indian Provisional Patent Application, Serial Number 729/DEL/2012, entitled “A Game Environment Utilizing A Lock Free Memory System,” filed on Mar. 13, 2012 (Attorney Docket No. 3291.146IN1/P1197PRV), which is incorporated by reference herein in its entirety.

### TECHNICAL FIELD

The present disclosure relates to gaming systems. In a particular embodiment, a game environment stores game data using a lock free storage.

### BACKGROUND

A recent trend in gaming is to make a game accessible to one or more users (e.g., players) by hosting the game online on a game server. In many cases, these hosted games are social, in that multiple users can interact with each other in the course of playing the hosted game. For example, in an online farming game, each user may be assigned a farm and one user may visit another user's farm to assist with certain tasks or challenges, such as watering crops, constructing buildings, harvesting crops, feeding animals, or harvesting buildings.

In many cases, when a visiting user performs a game action while visiting another user's farm, the game action may result in a change of game state for the visited farm. For example, the visiting user may cause a crop within the farm to change from one state to another. Because more than one user can access a farm (e.g., multiple users may visit at the same time, or the user that “owns” the farm may be accessing the farm while another user visits the farm), conflicts may occur. For example, two users may harvest the same crop, resulting in conflicting state changes. Such conflicts may occur when two users separately load the farm on their client devices and one user makes a change to the state of the crop but the state change does not propagate to the other user, who subsequently attempts to change the state of the crop.

To avoid conflicts and cheating, traditional online game systems utilize a transactional model to handle updates to games states stored by game servers. With such transactional models, user actions are not only executed locally on the client device but also executed on the game server. Thus, the client devices and game servers in traditional systems execute the same business logic for each game action initiated by users of the systems (e.g., the game action is executed by both the client and the server). While the game action is executed on the game server, the game server may lock or otherwise prevent access to the state of the game to prevent concurrent writes to the game state. Any sort of discrepancy will generate an out of sync (OOS) error. This contributes to negative user experience, which is detrimental to the success of any game.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 illustrates an example of a gaming environment for implementing various example embodiments;

FIG. 2 shows an example of a social network within a social graph, according to some embodiments;

FIG. 3 is a diagram illustrating an example of a game instance, according to some embodiments;

FIG. 4 is a diagram illustrating an example of a game delta record, according to some embodiments;

FIG. 5 is a block diagram showing the modules of the client devices and the gaming system, according to some embodiments;

FIG. 6 is a sequence diagram illustrating operations involved with a method of storing a game delta associated with an operation performed by a visiting user, according to some embodiments;

FIG. 7 is a sequence diagram illustrating operations involved with a method of loading the game instance for the user, according to some embodiments;

FIG. 8 illustrates an example data flow between example components of the example system of FIG. 1, according to some embodiments;

FIG. 9 illustrates an example network environment, in which various example embodiments may operate; and

FIG. 10 illustrates an example computing system architecture, which may be used to implement one or more of the methodologies described herein, according to some embodiments.

### DESCRIPTION OF EXAMPLE EMBODIMENTS

### Overview

Users of computer-implemented systems may access or otherwise interact with a gaming environment that supports a social game played by multiple users (e.g., players). According to example embodiments, a game environment may include a gaming system that manages the data relating to game instances belonging to or otherwise assigned to individual users. The term “game instance,” as used herein, may be used to refer to data or logic representing a game play area owned by one user (referred to as the “owning user”). A level, cityscape, land area, map, zone, area, region, location, game board, and any other suitable virtual environment are examples of game instances. In an example embodiment, the game environment may create a game instance for the owning user when the owning user initially registers or creates an account associated with the game hosted by the game system. Once a user is registered, the user then owns the created game instance in the sense that the owning user has the right to perform a variety of game actions that result in the state of the game instance to change. For example, the owning user may place building, animals, non-user characters, roads, decorations, and any other game object in the graphical representation of the game instance.

Further, the owning user may grant certain, possibly restrictive, rights to the game instance to other users. For example, the owning user may allow another user to visit the game instance by accepting a game friendship request from that user (referred to as the “visiting user”). Consequently, once the owning user accepts or invites the visiting user to form the game friendship, the visiting user may “visit” the game instance of the owning user and perform game actions relative to the owning user's game instance. For example, in a virtual farming game, some embodiments may allow a visiting user to visit a virtual farm owned by an owning user. The visiting user may then perform one or more game actions with respect to the owning user's virtual farm even though the virtual farm does not belong to the visiting user. For example, the visiting user may plant virtual seeds, harvest crops, leave gifts, exchange items, or perform any other suitable game action.

According to various embodiments, the gaming environment may provide a data path that utilizes a lock free memory system to store game state changes to a game instance stored by the gaming system. For the purpose of clarity, the term “lock free memory system” may be used herein to refer to a memory system that provides access to a particular game state of a game instance independent of whether the game state for the game instance is currently accessed by another client. When a user performs a game action on a game instance owned by the user, the game module operating on the client device may update the game state of the game instance stored in the lock free memory system.

To handle updates to game states caused by users visiting game instances of other users, example embodiments may provide a data path that further utilizes a delta catalog to store game deltas. As used herein, a “game delta” may refer to any suitable data that indicates a pending update to the game state of a game instance caused by a game action performed by a visiting user. Accordingly, when a user performs a game action on a virtual farm owned by another user, updates to the virtual farm are sent to and stored by the delta catalog.

According to some embodiments, utilizing a gaming environment that includes a lock free memory system simplifies game development, relative to gaming environments that simulate game actions on both the game client and the game server. Such may be the case because game developers may not have to replicate game simulation features in multiple places, possibly using different technologies. Further, the gaming environment may provide a comparatively simpler data path. For example, in some embodiments, the gaming environment is only doing very basic data validation and is not replaying the simulation. This data path may allow generic performance improvements without significant game logic.

These and other embodiments of the invention are described, by way of example, in further detail below.

### Example System

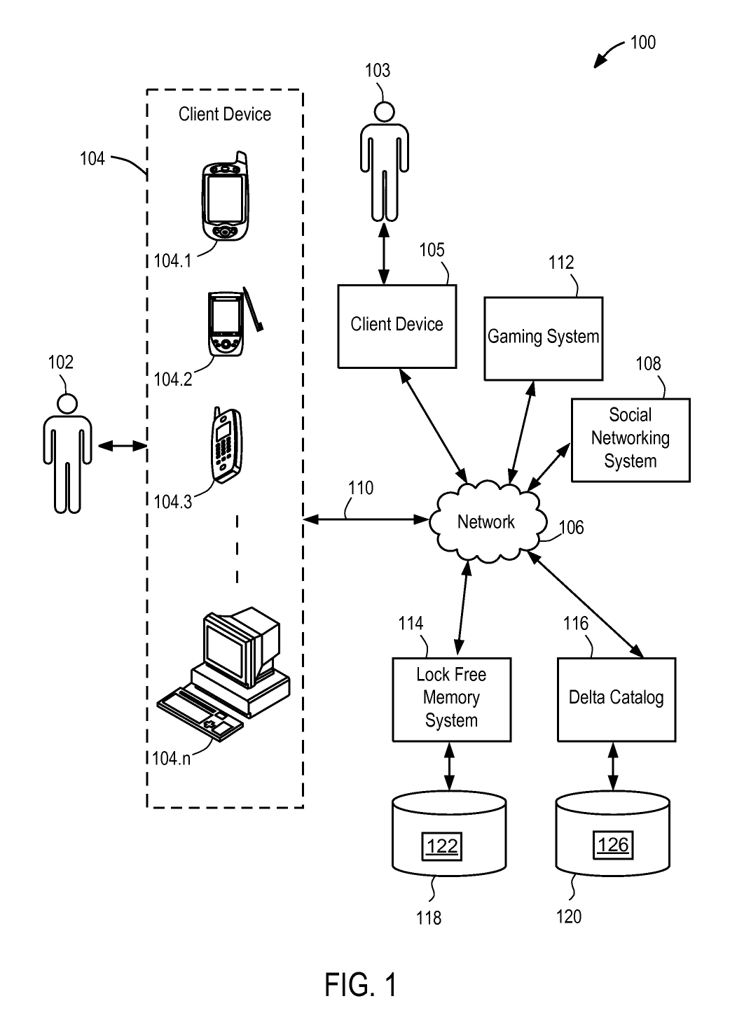

FIG. 1 illustrates an example of a gaming environment 100 for implementing various example embodiments. In some embodiments, the gaming environment 100 comprises users 102, 103, client devices 104, 105, a network 106, a social networking system 108, a gaming system 112, a lock free memory system 114, and a delta catalog 116. The components of the gaming environment 100 may be connected directly or over the network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Although FIG. 1 illustrates a particular example of the arrangement of the users 102, 103, the client devices 104, 105, the network 106, the social networking system 108, the gaming system 112, the lock free memory system 114, and the delta catalog 116, this disclosure includes any suitable arrangement or configuration of the users 102, 103, the client devices 104, 105, the network 106, the social networking system 108, the gaming system 112, the lock free memory system 114, and the delta catalog 116.

The client devices 104, 105 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client devices 104, 105 may access the social networking system 108 or the lock free memory system 112 directly, via the network 106, or via a third-party system. For example, the client device 104, 105 may access the lock free memory system 112 via the social networking system 108.

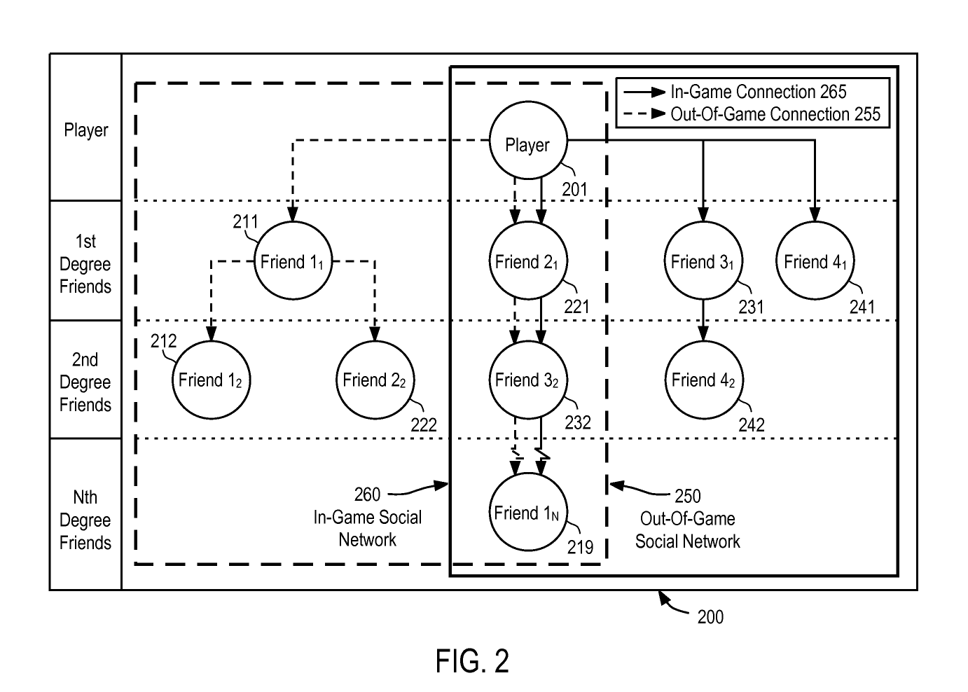

The social networking system 108 may include a network-addressable computing system that can host one or more social graphs (see for example FIG. 2), and may be accessed by the other components of system 100 either directly or via the network 106. The social networking system 108 may generate, store, receive, and transmit social networking data.

FIG. 2 shows an example of a social network within a social graph 200. Social graph 200 is shown by way of example to include an out-of-game social network 250, and an in-game social network 260. Moreover, the in-game social network 260 may include one or more users that are friends with Player 201 (e.g., Friend 231), and may include one or more other players that are not friends with Player 201. The social graph 200 may correspond to the various users associated with the virtual game.

With reference back to FIG. 1, the gaming system 112 may include a network-addressable computing system (or systems) that can host one or more virtual games, for example, online games. The gaming system 112 may generate, store, receive, and transmit game-related data, such as, for example, game account data, game input, game state data, and game displays. The gaming system 112 may be accessed by the other components of system 100 either directly or via the network 106. The users 102, 103 may use the client device 104, 105, respectively, to access, send data to, and receive data from the social networking system 108 and/or the gaming system 112.

The lock free memory system 114 may include a network-addressable computing system (or systems) that can maintain and provide access to game instances. The lock free memory system 114 may be accessed by the other components of system 100 directly, via the network 106, or via the gaming system 112. For example, as shown in FIG. 1, the lock free memory system 114 maintains game instance 122, as may be stored in a database 118. By way of example and not limitation, the game instance 122 may be owned by the user 102. For example, in a virtual farming game, the game instance 122 may store game data associated with a virtual farm owned by or otherwise assigned to the user 102. To simplify the discussion herein, the user 102 may be referred to as the owning user 102.

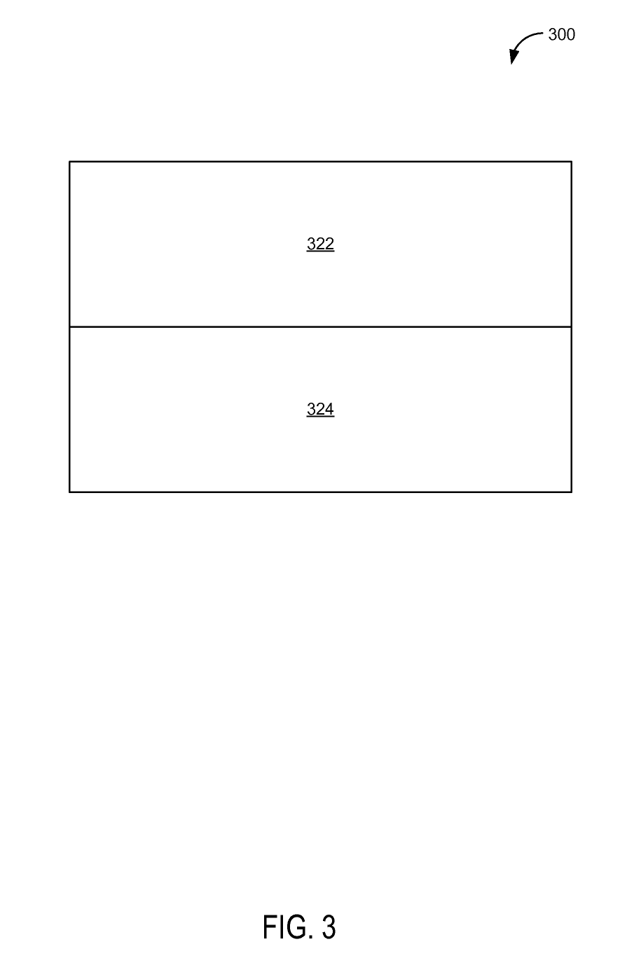

FIG. 3 is a diagram illustrating an example of a game instance record 300, according to example embodiments. As shown by FIG. 3, the game instance record 300 may include a game instance identifier (“ID”) 322 and game instance state 324. In example embodiments, the game instance ID uniquely identifies the game instance record 300 from other game instance records. Examples of game instance IDs include user identifiers, game identifiers, and combinations thereof. The game instance ID 322 may be generated when the user 102 registers or starts a game hosted by the game system 112.

The game instance state 324 includes logic that defines the current state of a game instance. The game instance state 324 may include, for example and without limitations, game-related data, such as game states, game events, user inputs. As described below, the game state record may be stored as a so-called Binary Large Object (BLOB). In some embodiments, while a user is not playing the virtual game, the corresponding game instance record 300 may be stored in the database 118. This enables a user to stop playing the game at any time without losing the current state of the game the user is in. When a user resumes playing the game next time, the gaming system 112 may retrieve the game instance state corresponding to the user associated with the game instance ID 322 to determine the most-recent values of the game-related data. In some embodiments, while a user is playing the virtual game, the gaming system 112 also loads the corresponding game instance record 300 into a memory cache so that the game system may have faster access to the game instance record 300 and the game-related data contained therein.

With reference back to FIG. 1, the delta catalog 116 may be a data store that generates, stores, receives, and/or transmits game deltas. As described above, a game delta may refer to data that represents a pending update to a game instance. Further, a game delta may be generated based on one or more game actions performed by a visiting user. For example, in a virtual farming game, a user may cause a client device 105 to load a game instance (e.g., a virtual farm) owned by another user. After the client device 105 loads the virtual farm, the user may cause the client device 105 to perform game actions with respect to the virtual farm. For example, the user may cause the client device 105 to harvest a crop. Rather than update the game instance stored in the lock free memory system 114, the client device 105 may generate a game delta that is communicated to the delta catalog 116.

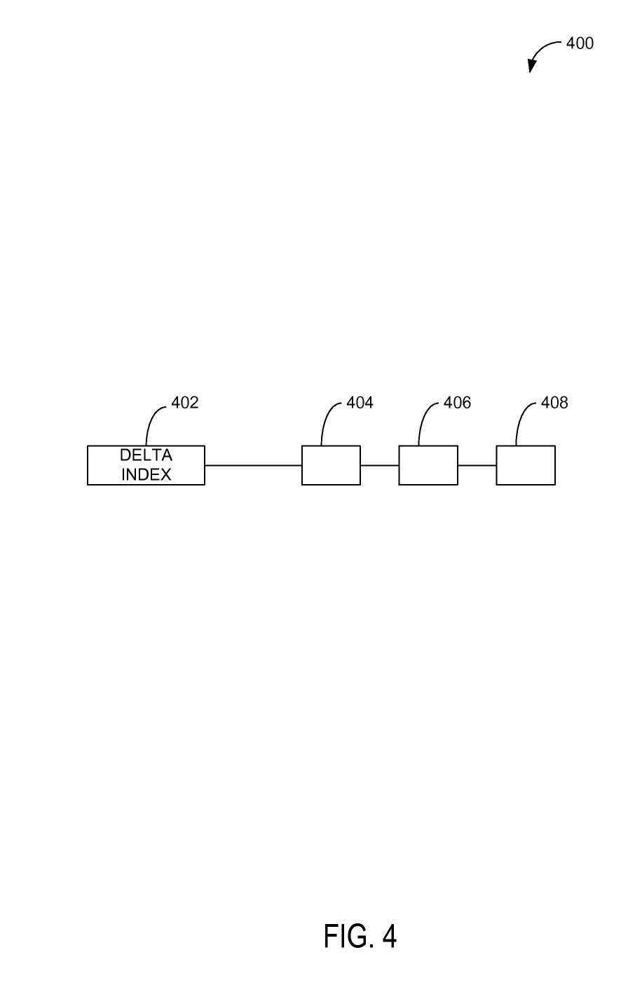

FIG. 4 is a diagram illustrating an example of a game delta record 400, according to example embodiments. As shown by FIG. 4, the game delta record 400 may include a delta index 402 and game deltas 404, 406, 408. The delta index 402 may be a unique identifier that associates the game deltas 404, 406, 408 with the owning user. As such, the delta index 402 may be derived from the user identifier of the owning user. In some cases, the game delta record 400 is unique for each game associated with a user. According to such cases, the delta index 402 may further be derived from data corresponding to a game identifier.

The game deltas 404, 406, 408 may each correspond to a game action performed by a visiting user on the game instance associated with the owning user. The game deltas 404, 406, 408 may include, by way of example and not limitation, a visiting user identifier, a game identifier, an operation performed by the visiting user, and one or more name-value pairs that identify one or more attributes that are to be update and corresponding values.

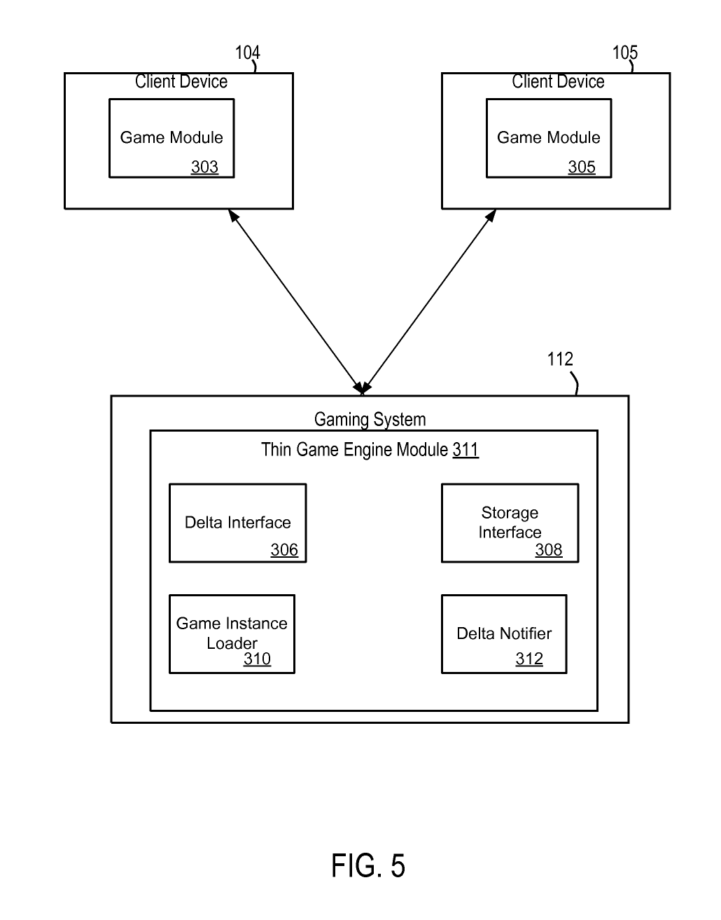

FIG. 5 is a block diagram showing the modules of the client devices 104, 105 and the gaming system 112, according to various embodiments. As shown in FIG. 5, the client devices 104, 105 include game modules 303, 305, respectively. As is further described in greater detail below, the game modules 303, 305 may be client side programs operating on the client devices 104, 105 to provide gaming operation to the users 102, 103 (see FIG. 1), respectively. In some embodiments, the game modules 303, 305 render and process gaming data received from the gaming system 112 to display a virtual game to a user. For example, the game modules 303, 305 may obtain the game instance 122 from the gaming system 112 through a storage interface 308 provided by the gaming system 112.

The game modules 303, 305 may also provide functionality to generate game deltas in response to a visiting user performing a game action on a game instance. When a game delta is generated, the game module 303 may store the generated game delta in the delta catalog 116 (see FIG. 1) through a delta interface 306 provided by the gaming system 112. Still further, the game modules 303, 305 may also provide functionality to store the game instance through the storage interface 308. In some embodiments, the game modules 303, 305 may be configured to determine whether the game deltas associated with a game instance are consistent with each other. As used herein, two or more game deltas may be inconsistent when the application of one of the deltas would prohibit the application of another game delta.

With reference back to the gaming system 112 shown in FIG. 5, gaming system 112 may include a thin game engine module 311 that provides a delta interface 306, a storage interface 308, a game instance loader 310, and a delta notifier 312. The delta interface 306 may be configured to provide the game modules 303, 305 an interface to access the game delta catalog 116. In an example embodiment, the game modules 303, 305 use the delta interface module 306 to send game deltas to the delta catalog when a visiting user performs a game action within a game instance associated with the another user. Further, in an example embodiment, the game modules 303, 305 may use the delta interface module 306 to retrieve game deltas when a user accesses a game instance owned by the user.

The storage interface 308 may be configured to provide the game modules 303, 305 access to the lock free memory system 114. In an example embodiment, the game modules 303, 305 may communicate with the lock free memory system 114 when a user loads a game instance or, in other cases, when a user saves a game instance that the user owns.

The game instance loader 310 may be configured to perform operations involved with loading a game instance record on a client device 104. For example, responsive to receiving a request from the game module 303, the game instance loader 310 may cause the storage interface 308 to retrieve a particular game state record, cause the delta interface 306 to retrieve the game deltas associated with the particular game instance record, and then communicate the particular game instance and the game deltas to the game module 303.

The delta notifier 312 may be configured to notify the game modules 303 with game deltas associated with a game state record that has been previously loaded by the game module 303. For example, if the game module 303 loads a game instance, the delta notifier 312 may notify the game module 303 with game deltas received from the game module 305.

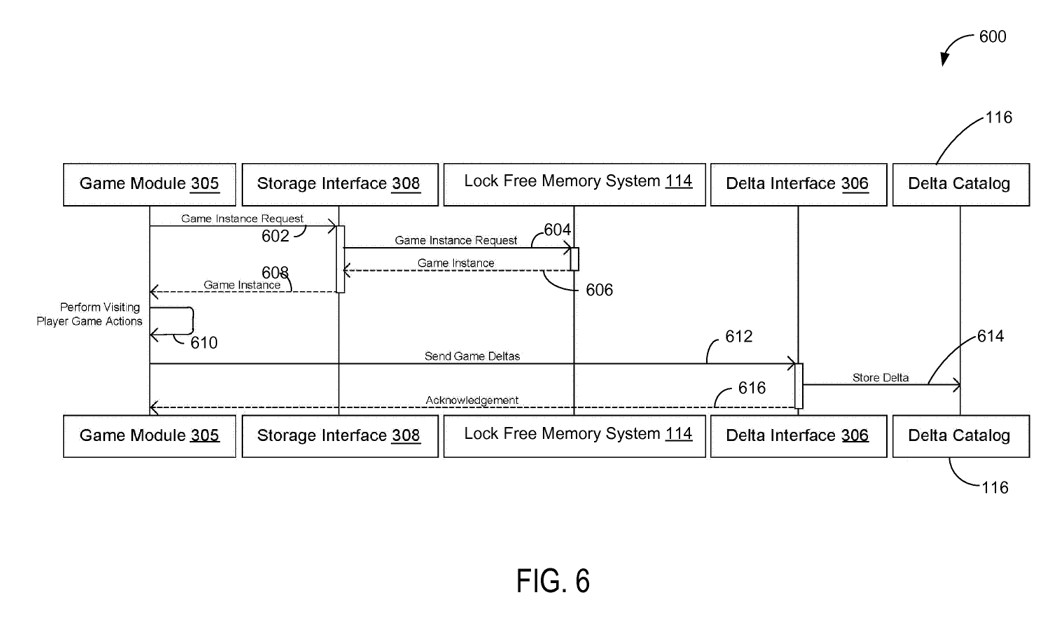

FIG. 6 is a sequence diagram illustrating operations involved with a method 600 of storing a game delta associated with an operation performed by a visiting user, according to example embodiments. In some embodiments, method 600 may include operations performed by the game module 305 and the modules of the gaming system 112. To simplify the discussions of embodiments disclosed herein, the game module 305 may correspond to a gaming client operated by the user 103 (see FIG. 1).

At operation 602, the game module 305 may obtain game data associated with the game instance 122. As described above, the game instance 122 is owned by user 102 but requested by player 103. As FIG. 6 shows, operation 602 may involve the game module 305 sending a request message to the storage interface 308. The game module 305 may send the request message in response to the user 103 selecting an icon associated with the user 102, for example. The request message sent as part of operation 602 may include game instance identifier (e.g., a user identifier, a game identifier, or some combination thereof).

Responsive to receiving the request message sent as part of operation 602, the storage interface 308 may then access the lock free memory server 114 to access the game instance 122. This is shown as operation 604. In some embodiments, the game instance 122 identified by matching the game instance identifier sent via operation 602 with the index corresponding to the game instance 122.

At operation 606, the lock free memory server 114 returns the game instance 122 to the storage interface 308. In turn, at operation 608, the storage interface 308 sends the game instance 122 to the game module 305. It is to be appreciated that the game module 305 may obtain the game instance (operations 602-608) without or absent locking the game instance from other users.

At operation 610, after the game module 305 obtains the game instance 122 owned by the user 102, the game module 305 may provide the user 103, as a visiting user, with the capability to perform a variety of game actions in connection with the game instance. As one example, in a virtual farming game, the user 103 may harvest a crop grown within a virtual farm associated with the user. As another example, the visiting user may leave a gift within the game board for the first user.

Such game actions may alter the state of the game instance 122. For example, a tile that has been harvested may visually change from a tile depicting a mature crop to a tile depicting a crop that has been cut. In some embodiments, the game module 305 updates the local copy of the game instance to reflect the operations performed by the user 103. Thus, the game module 305 may show the crop having been harvested.

Further, rather than updating the game instance 122 as stored in with the gaming system 112, the game module 305 may generate a game delta and cause the gaming system 112 to store the generated game delta. For example, at operation 612, the game module 305 sends a game delta to the game delta interface 306. As described above, a game delta may include data that is usable to update a game instance, such as an operation or one or more name value pairs. In some embodiments, operation 612 may also involve sending a game instance identifier with the game delta. Responsive to receiving the game delta and the game instance identifier, the game delta interface 306 may store the game delta in the delta catalog 116. This is shown as operation 614. In some embodiments, at operation 616, the delta catalog 116 and/or the game delta interface 306 may send an acknowledgement to the game module 305 to indicate whether the game delta was stored successfully. It is to be appreciated that the game module 305 may store the game delta (operations 612-616) without or absent locking the game instance from other users.

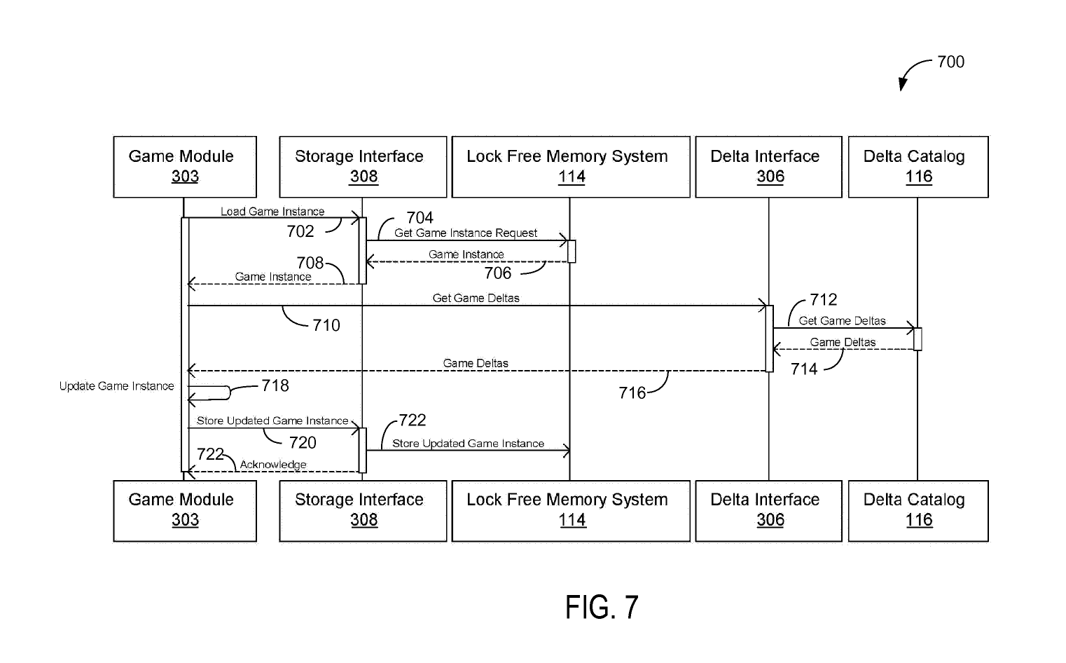

FIG. 7 is a sequence diagram illustrating operations involved with a method of loading the game instance 122 for the user 102, according to example embodiments. In some embodiments, method 700 may include operations performed by the game module 303 and the modules of the gaming system 112. As described above, the game instance 122 is owned by user 102.

At operation 702, the game module 303 may obtain the game instance 122. In some embodiments, the game module 303 may send a request message to the storage interface 308 to load the game instance 122. In example embodiments, the request message sent as part of operation 702 may include a game instance identifier associated with the game instance (e.g., a user identifier, a game identifier, or a combination thereof).

Responsive to receiving the request message sent at operation 702, the storage interface 308 may send, at operation 704, a request for the game instance associated with the user 102. As shown in FIG. 7, such a request may be sent from the storage interface 308 to the lock free memory server 112. In turn, the lock free memory server 112 returns, at operation 706, the game state associated with the game instance 122. Further, at operation 708, the storage interface 308 may also return the game instance 122 to the game module 303. It is to be appreciated that the game module 303 may obtain the game instance (operations 702-708) without or absent locking the game instance from other users.

After obtaining the game instance 122 owned by the user 102, the game module 303 may then obtain the game deltas 126 associated with the game instance 122. As described above, a game delta may represent pending updates to a game instance caused by game actions performed by a visiting user. As FIG. 7 shows, the game module 303 may obtain the game deltas associated with a game state by sending a game delta request message, at operation 710, to the delta interface 306. According to some embodiments, the game delta request message may include a game instance identifier (e.g., a user identifier, game identifier, or some combination thereof) to specify to the game system which game deltas are to be retrieved. Responsive to receiving the game delta request message, at operation 712, the delta interface 306 may access the delta catalog 116 to obtain the requested game deltas. The delta catalog 116 may use the game instance identifier received in the game delta request message to identify one or more game deltas that are associated with the game instance. The identified game deltas are then returned to the module 303 at operations 714, 716.

At operation 718, the game module 303 may iterate through the list of game deltas (previously received at operation 716) to update the game instance (previously received at operation 708) stored locally by the game module 303. In some embodiments, operation 718 may involve game module 303 verifying that the list of game deltas is consistent with each other. For example the game module 303 may verify that each individual game delta may be used to update the game instance without conflicting with another game delta. Such a conflict may occur when two game deltas represent game actions performed on a same game object. Two game deltas representing a harvesting operation performed on the same virtual crop is an example of conflicting game deltas. After the game deltas have been verified, the game module 303 may then apply each game delta to the game instance stored locally on the game module 303.

After game module 303 uses the game deltas to update the local game instance, the game module 303 may then store the updated game instance within the game server. Storing the updated game instance may involve the game module 303 sending an update request message to the storage interface 308. This is shown as operation 720. The update request message may include a game instance identifier. At operation 722, the storage interface 308 may, in turn, access the lock free memory server 114 to update the game instance that matches the game instance identifier used in the update request message. At operation 724, the storage interface 308 may return an acknowledgement message indicating that the updated game instance was successfully saved. It is to be appreciated that the game module 303 may store the updated game instance (operations 720-724) without or absent locking the game instance from other users.

### Example Game Systems, Social Networks, and Social Graphs

As described above, the systems described herein may include, communicate, or otherwise interact with a game system. As such, a game system is now described to illustrate further embodiments. In an online multiuser game, users control player characters (PCs), a game engine controls non-player characters (NPCs), and the game engine also manages player character state and tracks states for currently active (e.g., online) users and currently inactive (e.g., offline) users.

A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a user (or a group of more than one users), the game engine may take into account the state of the player character (or group of PCs) that is playing, but also the state of one or more PCs of offline/inactive users who are connected to the current user (or PC, or group of PCs) through the game social graph but are not necessarily involved in the game at the time.

For example, User A with six friends on User A's team (e.g., the friends that are listed as being in the user's mob/gang/set/army/business/crew/etc. depending on the nature of the game) may be playing the virtual game and choose to confront User B who has 20 friends on User B's team. In some embodiments, a user may only have first-degree friends on the user's team. In other embodiments, a user may also have second-degree and higher degree friends on the user's team. To resolve the game event, in some embodiments the game engine may total up the weapon strength of the seven members of User A's team and the weapon strength of the 21 members of User B's team and decide an outcome of the confrontation based on a random variable applied to a probability distribution that favors the side with the greater total. In some embodiments, all of this may be done without any other current active participants other than User A (e.g., User A's friends, User, B, and User B's friends could all be offline or inactive). In some embodiments, the friends in a user's team may see a change in their state as part of the outcome of the game event. In some embodiments, the state (assets, condition, level) of friends beyond the first degree are taken into account.

### Example Gaming Systems

A virtual game may be hosted by the gaming system 108.2, which can be accessed using any suitable connection 110 with a suitable client device 104. A user may have a game account on the gaming system 108.2, wherein the game account may contain a variety of information associated with the user (e.g., the user's personal information, financial information, purchase history, player character state, game state, etc.). In some embodiments, a user may play multiple games on the gaming system 108.2, which may maintain a single game account for the user with respect to the multiple games, or multiple individual game accounts for each game with respect to the user. In some embodiments, the gaming system 108.2 may assign a unique identifier to a user 102 of a virtual game hosted on the gaming system 108.2. The gaming system 108.2 may determine that the user 102 is accessing the virtual game by reading the user's cookies, which may be appended to HTTP requests transmitted by the client device 104, and/or by the user 102 logging onto the virtual game.

In some embodiments, the user 102 accesses a virtual game and control the game's progress via the client device 104 (e.g., by inputting commands to the game at the client device 104). The client device 104 can display the game interface, receive inputs from the user 102, transmit user inputs or other events to the game engine, and receive instructions from the game engine. The game engine can be executed on any suitable system (such as, for example, the client device 104, the social networking system 108.1, or the gaming system 108.2). For example, the client device 104 may download client components of a virtual game, which are executed locally, while a remote game server, such as the gaming system 108.2, provides backend support for the client components and may be responsible for maintaining application data of the game, processing the inputs from the user 102, updating and/or synchronizing the game state based on the game logic and each input from the user 102, and transmitting instructions to the client device 104. As another example, when the user 102 provides an input to the game through the client device 104 (such as, for example, by typing on the keyboard or clicking the mouse of the client device 104), the client components of the game may transmit the user's input to the gaming system 108.2.

In some embodiments, the user 102 accesses particular game instances of a virtual game. A game instance is a copy of a specific game play area that is created during runtime. In some embodiments, a game instance is a discrete game play area where one or more users 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game, and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm.

In some embodiments, a game engine interfaces with a social graph. Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the gaming system 108.2, which is managed by the game operator. In other embodiments, the social graph is part of a social networking system 108.1 managed by a third party (e.g., Facebook, Friendster, Myspace). In yet other embodiments, the user 102 has a social network on both the gaming system 108.2 and the social networking system 108.1, wherein the user 102 can have a social network on the gaming system 108.2 that is a subset, superset, or independent of the user's social network on the social networking system 108.1. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 108.1, the gaming system 108.2, or both.

### Example Systems and Methods

Returning to FIG. 2, the User 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to User 201. As used herein, the terms “user” and “player” can be used interchangeably and can refer to any user in an online multiuser game system or social networking system. As used herein, the term “friend” can mean any node within a user's social network.

As shown in FIG. 2, User 201 has direct connections with several friends. When User 201 has a direct connection with another individual, that connection is referred to as a first-degree friend. In out-of-game social network 250, User 201 has two first-degree friends. That is, User 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a user to another user is considered the degree of separation. For example, FIG. 2 shows that User 201 has three second-degree friends to which User 201 is connected via User 201's connection to User 201's first-degree friends. Second-degree Friend 1₂ 212 and Friend 2₂ 222 are connected to User 201 via User 201's first-degree Friend 1₁ 211. The limit on the depth of friend connections, or the number of degrees of separation for associations, that User 201 is allowed is typically dictated by the restrictions and policies implemented by the social networking system 108.1.

In various embodiments, User 201 can have Nth-degree friends connected to him through a chain of intermediary degree friends as indicated in FIG. 2. For example, Nth-degree Friend 1_{N} 219 is connected to User 201 within in-game social network 260 via second-degree Friend 3₂ 232 and one or more other higher-degree friends.

In some embodiments, a user (or player character) has a social graph within an online multiuser game that is maintained by the game engine and another social graph maintained by a separate social networking system. FIG. 2 depicts an example of in-game social network 260 and out-of-game social network 250. In this example, User 201 has out-of-game connections 255 to a plurality of friends, forming out-of-game social network 250. Here, Friend 1₁ 211 and Friend 2₁ 221 are first-degree friends with User 201 in User 201's out-of-game social network 250. User 201 also has in-game connections 265 to a plurality of users, forming in-game social network 260. Here, Friend 2₁ 221, Friend 3₁ 231, and Friend 4₁ 241 are first-degree friends with User 201 in User 201's in-game social network 260. In some embodiments, a game engine can access in-game social network 260, out-of-game social network 250, or both.

In some embodiments, the connections in a user's in-game social network is formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that could be the case.

FIG. 7 illustrates an example data flow between example components of an example system 800. One or more of the components of the example system 800 may correspond to one or more of the components of the example system 100. In some embodiments, system 800 includes a client system 830, a social networking system 820a, and a gaming system 820b. The components of system 800 can be connected to each other in any suitable configuration, using any suitable type of connection. The components may be connected directly or over any suitable network. The client system 830, the social networking system 820a, and the gaming system 820b may have one or more corresponding data stores such as the local data store 825, the social data store 845, and the game data store 865, respectively.

The client system 830 may receive and transmit data 823 to and from the gaming system 820b. This data can include, for example, a web page, a message, a game input, a game display, a HTTP packet, a data request, transaction information, and other suitable data. At some other time, or at the same time, the gaming system 820b may communicate data 843, 847 (e.g., game state information, game system account information, page info, messages, data requests, updates, etc.) with other networking systems, such as the social networking system 820a (e.g., Facebook, Myspace, etc.). The client system 830 can also receive and transmit data 827 to and from the social networking system 820a. This data can include, for example, web pages, messages, social graph information, social network displays, HTTP packets, data requests, transaction information, updates, and other suitable data.

Communication between the client system 830, the social networking system 820a, and the gaming system 820b can occur over any appropriate electronic communication medium or network using any suitable communications protocols. For example, the client system 830, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the gaming system 820b, the BLOB containing the game state for the instance corresponding to the user may be transmitted to the client system 830 for use by a client-side executed object to process. In some embodiments, the client-side executable is a FLASH-based game, which can de-serialize the game state data in the BLOB. As a user plays the game, the game logic implemented at the client system 830 maintains and modifies the various game state parameters locally. The client-side game logic may also batch game events, such as mouse clicks, and transmit these events to the gaming system 820b. Gaming system 820b may itself operate by retrieving a copy of the BLOB from a database or an intermediate memory cache (memcache) layer. The gaming system 820b can also de-serialize the BLOB to resolve the game state parameters and execute its own game logic based on the events in the batch file of events transmitted by the client to synchronize the game state on the server side. The gaming system 820b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 830. For example, a client application downloaded to the client system 830 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages is associated with or accessed by the social networking system 820a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 830, either caused by an action of a game user or by the game logic itself, the client system 830 may need to inform the gaming system 820b of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies.

In some embodiments, one or more objects of a game is represented as an ADOBE FLASH object. Flash may manipulate vector and raster graphics, and supports bidirectional streaming of audio and video. “Flash” may mean the authoring environment, the user, or the application files. In some embodiments, the client system 830 may include a Flash client. The Flash client may be configured to receive and run Flash application or game object code from any suitable networking system (such as, for example, the social networking system 820a or the gaming system 820b). In some embodiments, the Flash client is run in a browser client executed on the client system 830. A user can interact with Flash objects using the client system 830 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, attack, shoot, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 830, the Flash client may send the events that caused the game state changes to the in-game object to the gaming system 820b. However, to expedite the processing and hence the speed of the overall gaming experience, the Flash client may collect a batch of some number of events or updates into a batch file. The number of events or updates may be determined by the Flash client dynamically or determined by the gaming system 820b based on server loads or other factors. For example, client system 830 may send a batch file to the gaming system 820b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 830, the gaming system 820b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, gaming system 820b may retrieve the corresponding BLOB from the database to determine the most-recent values of the game-related data. In some embodiments, while a user is playing the virtual game, the gaming system 820b also loads the corresponding BLOB into a memory cache so that the game system may have faster access to the BLOB and the game-related data contained therein.

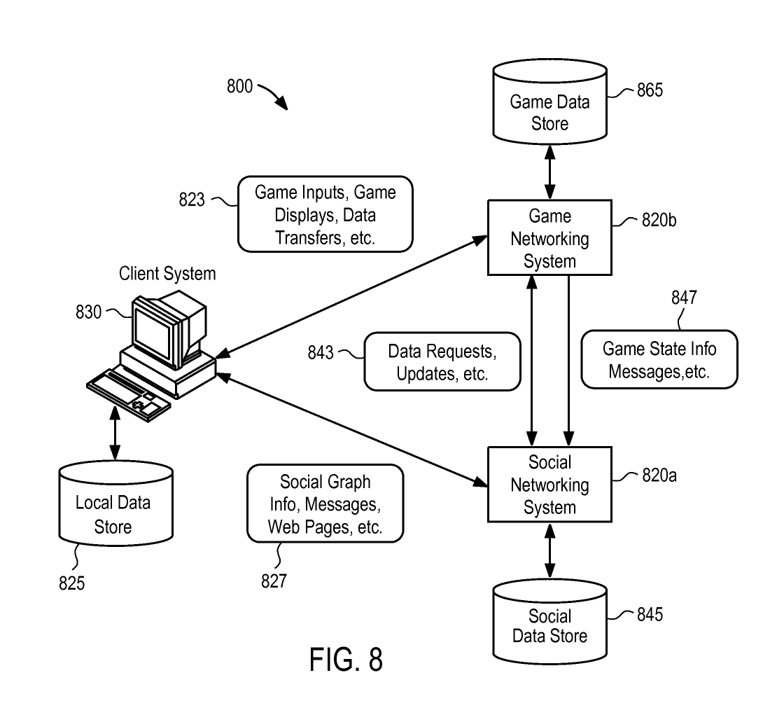

Various embodiments may operate in a wide area network environment, such as the Internet, including multiple network addressable systems. FIG. 8 illustrates an example network environment 900, in which various example embodiments may operate. Network cloud 960 generally represents one or more interconnected networks, over which the systems and hosts described herein can communicate. Network cloud 960 may include packet-based wide area networks (such as the Internet), private networks, wireless networks, satellite networks, cellular networks, paging networks, and the like. As FIG. 8 illustrates, various embodiments may operate in a network environment 900 comprising one or more networking systems, such as a social networking system 920a, a gaming system 920b, and one or more client systems 930. The components of the social networking system 920a and the gaming system 920b operate analogously; as such, hereinafter they may be referred to simply as the networking system 920. The client systems 930 are operably connected to the network environment 900 via a network service provider, a wireless carrier, or any other suitable means.

The networking system 920 is a network addressable system that, in various example embodiments, comprises one or more physical servers 922 and data stores 924. The one or more physical servers 922 are operably connected to computer network cloud 960 via, by way of example, a set of routers and/or networking switches 926. In an example embodiment, the functionality hosted by the one or more physical servers 922 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 922 may host functionality directed to the operations of the networking system 920. Hereinafter servers 922 may be referred to as server 922, although the server 922 may include numerous servers hosting, for example, the networking system 920, as well as other content distribution servers, data stores, and databases. Data store 924 may store content and data relating to, and enabling, operation of, the networking system 920 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc.

Logically, data store 924 corresponds to one or more of a variety of separate and integrated databases, such as relational databases and object-oriented databases, that maintain information as an integrated collection of logically related records or files stored on one or more physical systems. Structurally, data store 924 may generally include one or more of a large class of data storage and management systems. In some embodiments, data store 924 may be implemented by any suitable physical system(s) including components, such as one or more database servers, mass storage media, media library systems, storage area networks, data storage clouds, and the like. In one example embodiment, data store 924 includes one or more servers, databases (e.g., MySQL), and/or data warehouses. Data store 924 may include data associated with different networking system 920 users and/or client systems 930.

The client system 930 is generally a computer or computing device including functionality for communicating (e.g., remotely) over a computer network. The client system 930 may be a desktop computer, laptop computer, personal digital assistant (PDA), in- or out-of-car navigation system, smart phone or other cellular or mobile phone, or mobile gaming device, among other suitable computing devices. Client system 930 may execute one or more client applications, such as a Web browser.

When a user at a client system 930 desires to view a particular webpage (hereinafter also referred to as target structured document) hosted by the networking system 920, the user's web browser, or other document rendering engine or suitable client application, formulates and transmits a request to the networking system 920. The request generally includes a URL or other document identifier as well as metadata or other information. By way of example, the request may include information identifying the user, a timestamp identifying when the request was transmitted, and/or location information identifying a geographic location of the user's client system 930 or a logical network location of the user's client system 930.

Although the example network environment 900 described above and illustrated in FIG. 8 is described with respect to the social networking system 920a and the gaming system 920b, this disclosure encompasses any suitable network environment using any suitable systems. For example, a network environment may include online media systems, online reviewing systems, online search engines, online advertising systems, or any combination of two or more such systems.

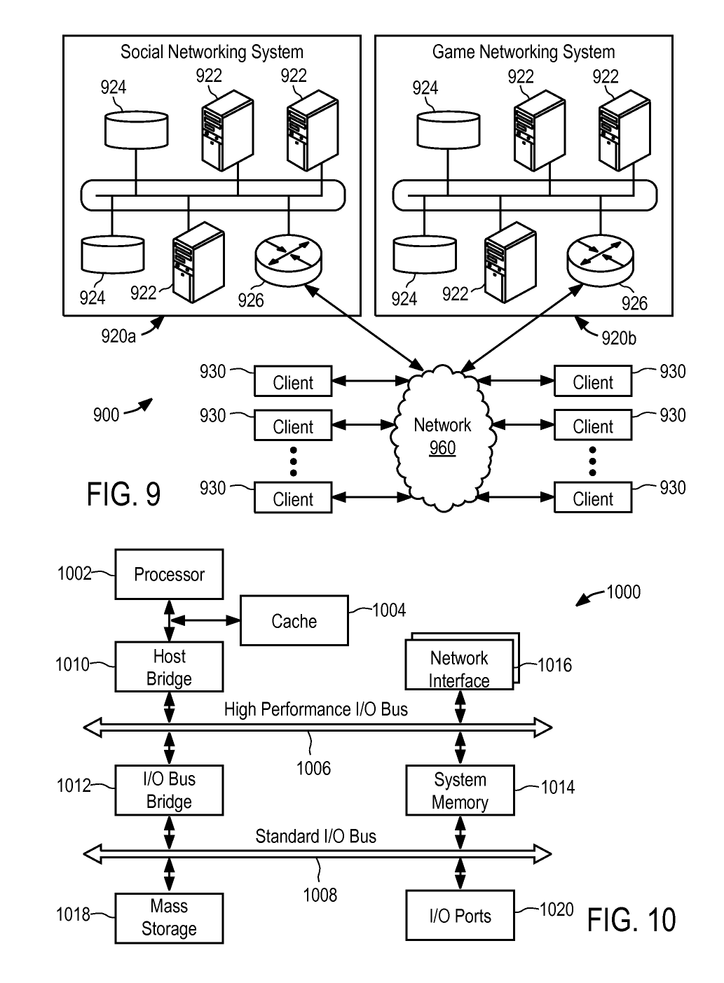

FIG. 9 is illustrates an example computing system architecture, which may be used to implement a server 922 or a client system 930. In one embodiment, the hardware system 1000 comprises a processor 1002, a cache memory 1004, and one or more executable modules and drivers, stored on a tangible computer-readable storage medium, directed to the functions described herein. Additionally, the hardware system 1000 may include a high performance input/output (I/O) bus 1006 and a standard I/O bus 1008. A host bridge 1010 may couple the processor 1002 to the high performance I/O bus 1006, whereas the I/O bus bridge 1012 couples the two buses 1006 and 1008 to each other. A system memory 1014 and one or more network/communication interfaces 1016 may couple to the bus 1006. The hardware system 1000 may further include video memory (not shown) and a display device coupled to the video memory. Mass storage 1018 and I/O ports 1020 may couple to the bus 1008. The hardware system 1000 may optionally include a keyboard, a pointing device, and a display device (not shown) coupled to the bus 1008. Collectively, these elements are intended to represent a broad category of computer hardware systems.

The elements of the hardware system 1000 are described in greater detail below. In particular, the network interface 1016 provides communication between the hardware system 1000 and any of a wide range of networks, such as an Ethernet (e.g., IEEE 802.3) network, a backplane, etc. The mass storage 1018 provides permanent storage for the data and programming instructions to perform the above-described functions implemented in servers 922 of FIG. 8, whereas system memory 1014 (e.g., DRAM) provides temporary storage for the data and programming instructions when executed by the processor 1002. I/O ports 1020 are one or more serial and/or parallel communication ports that provide communication between additional peripheral devices, which may be coupled to the hardware system 1000.

The hardware system 1000 may include a variety of system architectures and various components of the hardware system 1000 may be rearranged. For example, cache memory 1004 may be on-chip with the processor 1002. Alternatively, the cache memory 1004 and the processor 1002 may be packed together as a “processor module,” with processor 1002 being referred to as the “processor core.” Furthermore, certain embodiments of the present disclosure may neither require nor include all of the above components. For example, the peripheral devices shown coupled to the standard I/O bus 1008 may couple to the high performance I/O bus 1006. In addition, in some embodiments, only a single bus may exist, with the components of the hardware system 1000 being coupled to the single bus. Furthermore, the hardware system 1000 may include additional components, such as additional processors, storage devices, or memories.

An operating system manages and controls the operation of the hardware system 1000, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
assigning a game instance with a first user, the game instance being stored in a game instance record maintained by a lock free memory system, the game instance being owned by the first user;
receiving an indication that a second user has performed a game action that changes the state of the game instance owned by the first user; and
storing, using one or more processors, a game delta in a game delta catalog, the game delta representing a change to the game instance owned by the first user, the storing being performed absent locking the game instance record.

2. The computer-implemented method of claim 1, further comprising:
before receiving the indication, providing access to the game instance to the second user using the lock free memory system, the lock free memory system providing the access to the game instance absent a lock on the game instance.

3. The computer-implemented method of claim 1, further comprising:
receiving an additional indication that a third user has performed an additional game action involving the game instance associated with the first user; and
responsive to receiving the additional indication, storing an additional game delta in the game delta catalog, the additional game delta representing an additional change to the game instance associated with the first user.

4. The computer-implemented method of claim 3, wherein the game delta catalog maintains a plurality of game deltas associated with the game instance.

5. The computer-implemented method of claim 1, further comprising:
receiving an additional indication that the first user has performed an additional game action involving the game instance associated with the first user; and
responsive to receiving the additional indication, directly updating the game instance record stored by the lock free memory system.

6. The computer-implemented method of claim 1, further comprising, prior to receiving the indication that the second user has performed the game action:
receiving a request for the game instance, the request being initiated by the second user;
determining that the first user previously allowed the second user access to the game instance; and
providing, using the lock free memory system, the game instance to the second user.

7. The computer-implemented method of claim 1, further comprising:
receiving a request for the game instance from a game module being operated by the first user;
responsive to the request for the game instance:
sending the game instance to the game module being operated by the first user; and
sending the game delta to the game module being operated by the first user.

8. The computer-implemented method of claim 1, wherein the game instance includes data representing at one of: a level, a cityscape, a land area, a map, a zone, an area, a region, a location, a game board, or any other suitable virtual environment.

9. A computer system, comprising:
at least one processor; and
a thin game engine module implemented by the at least one processor and configured to:
assign a game instance with a first user, the game instance being stored in a game instance record maintained by a lock free memory system, the game instance being owned by the first user;
receive an indication that a second user has performed a game action that changes the state of the game instance owned by the first user; and
store, using one or more processors, a game delta in a game delta catalog, the game delta representing a change to the game instance owned by the first user, the storing being performed absent locking the game instance record.

10. The computer system of claim 9, wherein the thin game engine module is further configured to:
before receiving the indication, provide access to the game instance to the second user using the lock free memory system, the lock free memory system providing the access to the game instance absent a lock on the game instance.

11. The computer system of claim 9, wherein the thin game engine module is further configured to:
receive an additional indication that a third user has performed an additional game action involving the game instance associated with the first user; and
responsive to receiving the additional indication, store an additional game delta in the game delta catalog, the additional game delta representing an additional change to the game instance associated with the first user.

12. The computer system of claim 11, wherein the game delta catalog maintains a plurality of game deltas associated with the game instance.

13. The computer system of claim 9, wherein the thin game engine module is further configured to:
receive an additional indication that the first user has performed an additional game action involving the game instance associated with the first user; and
responsive to receiving the additional indication, directly update the game instance record stored by the lock free memory system.

14. The computer system of claim 9, wherein the thin game engine module is further configured to, prior to receiving the indication that the second user has performed the game action:
receive a request for the game instance, the request being initiated by the second user;
determine that the first user previously allowed the second user access to the game instance; and
provide, using the lock free memory system, the game instance to the second user.

15. The computer system of claim 9, wherein the thin game engine module is further configured to:
receive a request for the game instance from a game module being operated by the first user;
responsive to the request for the game instance:
send the game instance to the game module being operated by the first user; and
send the game delta to the game module being operated by the first user.

16. The computer system of claim 9, wherein the game instance includes data representing at one of: a level, a cityscape, a land area, a map, a zone, an area, a region, a location, a game board, or any other suitable virtual environment.

17. A non-transitory computer-readable medium storing executable instructions thereon, which, when executed by a processor, cause the processor to perform operations comprising:
assigning a game instance with a first user, the game instance being stored in a game instance record maintained by a lock free memory system, the game instance being owned by the first user;
receiving an indication that a second user has performed a game action that changes the state of the game instance owned by the first user; and
storing, using one or more processors, a game delta in a game delta catalog, the game delta representing a change to the game instance owned by the first user, the storing being performed absent locking the game instance record.

18. The non-transitory computer-readable medium of claim 17, wherein the operations further comprises:
before receiving the indication, providing access to the game instance to the second user using the lock free memory system, the lock free memory system providing the access to the game instance absent a lock on the game instance.

19. The non-transitory computer-readable medium of claim 17, wherein the operations further comprises:
receiving an additional indication that a third user has performed an additional game action involving the game instance associated with the first user; and
responsive to receiving the additional indication, storing an additional game delta in the game delta catalog, the additional game delta representing an additional change to the game instance associated with the first user.

20. The non-transitory computer-readable medium of claim 17, wherein the operations further comprises:
receiving a request for the game instance, the request being initiated by the second user;
determining that the first user previously allowed the second user access to the game instance; and
providing, using the lock free memory system, the game instance to the second user.
